(19) United States
(12) Patent Application Publication
(10) Pub. No.: US 2004/0025384 A1
(43) Pub. Date: Feb. 12, 2004

(54) Point of purchase display

(76) Inventors: Robert J. Ptacek, Medina, OH (US); Howard S. Elinsky, Chagrin Falls, OH (US)

Correspondence Address: Warren A. Sklar, Renner, Otto, Boisselle & Sklar, LLP, 19th Floor, 1621 Euclid Avenue, Cleveland, OH, 44115-2191, US

(21) Appl. No.: 10/216,420

(22) Filed: Aug. 9, 2002

(51) Int. Cl. G09F 1/10; A47F 7/16

(52) U.S. Cl. 40/124.4; 211/45

(57) ABSTRACT

A point of purchase display includes a card stock having a number of slots therein, the slots being covered by a flap portion that is hinged at the bottom. Inserting of a right angle device through a slot perforates the material initially holding the flap in place and allows the flap to provide a hinge-like function that may be cooperative with the right angle device to retain it with desired retention characteristics. A method for displaying a right angle device in a point of purchase display. Another embodiment of point of purchase display has a slot and a shoulder in card stock material which cooperate with the right angle device to retain it and the card stock material as a unit for displaying.

### TECHNICAL FIELD

This invention relates, generally, as indicated, to point of purchase displays and, more particularly, to display cards for mounting relative to an object for display for sale or the like.

### BACKGROUND

There are various types of display devices, some of which are known as point of purchase display. It is difficult to design a point of purchase display for displaying clearly and efficiently the device being displayed for sale when that device is relatively cumbersome, rigid, or has a relatively large size in one or more directions and/or directions while being relatively small or thin in other dimensions.

### SUMMARY

Briefly, according to one aspect of the present invention, a point of purchase display includes a card-like device of adequate rigidity to retain its shape absent an input, such as a bending, folding or like force, and a number of slot-like openings in the card-like device of a size, shape and placement to receive an elongate member having a given thickness and width accommodated by the slot-like openings.

According to another aspect, a point of purchase display includes a card-like device of adequate rigidity to retain its shape absent an input, such as a bending, folding or like force, and a number of slot-like openings in the card-like device of a size, shape and placement to receive an elongate member having a given thickness and width accommodated by the slot-like openings, and a foldable portion of the card-like device foldable to at least partly fill a respective slot-like opening and having adequate resiliency when unfolded to maintain some degree of engagement with an elongate member in the slot-like opening.

A method of displaying right-angle devices that have two legs oriented at generally right angles relative to each other, comprising

inserting one leg through a slot-like opening in a card-like device that has a number of slot-like openings in vertically spaced apart relation,

allowing the other leg of the right-angle device to extend outward from the card-like device, and

allowing overlap of the one leg of each of two right-angle devices partly to overlap each other to urge each other to maintain a relatively stable relation to the card-like device and to each other while mounted in the card-like device.

A method of displaying right-angle devices that have two legs oriented at generally right angles relative to each other, comprising

inserting one leg through a slot-like opening in a card-like device that has a number of slot-like openings in vertically spaced apart relation,

allowing the other leg of the right-angle device to extend outward from the card-like device, and

using a folded flap-like portion of card-like device material to engage at least a portion of one of the legs of a right-angle device to help retain it in position relative to the card-like device.

A point of purchase display for a right angle device that has two legs oriented at relatively right angles to each other and an opening in one of the legs, comprising

a card having a main body,

notch in the main body for fitting within the opening in one of the legs such that at least part fo the card engages part of the material of the leg,

and a slot in the main body for receiving part of the other.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

In the annexed drawings:

FIG. 1 is front view of a point of purchase display embodying the invention;

FIG. 2 is a side elevation view of the display of FIG. 1—the view from both sides is the same or nearly the same;

FIG. 3 is a top view of the display of FIG. 1—the view from both the top and the bottom are the same or nearly the same;

FIG. 4 is a front view of the display of FIG. 1 with right angle devices positioned therein;

FIG. 5 is a side view of the display of FIG. 1 with the right angle devices positioned therein;

FIG. 6 is a back view of the display of FIG. 1 with the right angle devices positioned therein;

FIG. 7 is an isometric view of an exemplary right-angle device used in the point of purchase displays of the invention; and

FIGS. 8, 9 and 10 are, respectively, front, end and schematic isometric, partly in section, of another embodiment of point of purchase display embodying the invention.

### DESCRIPTION

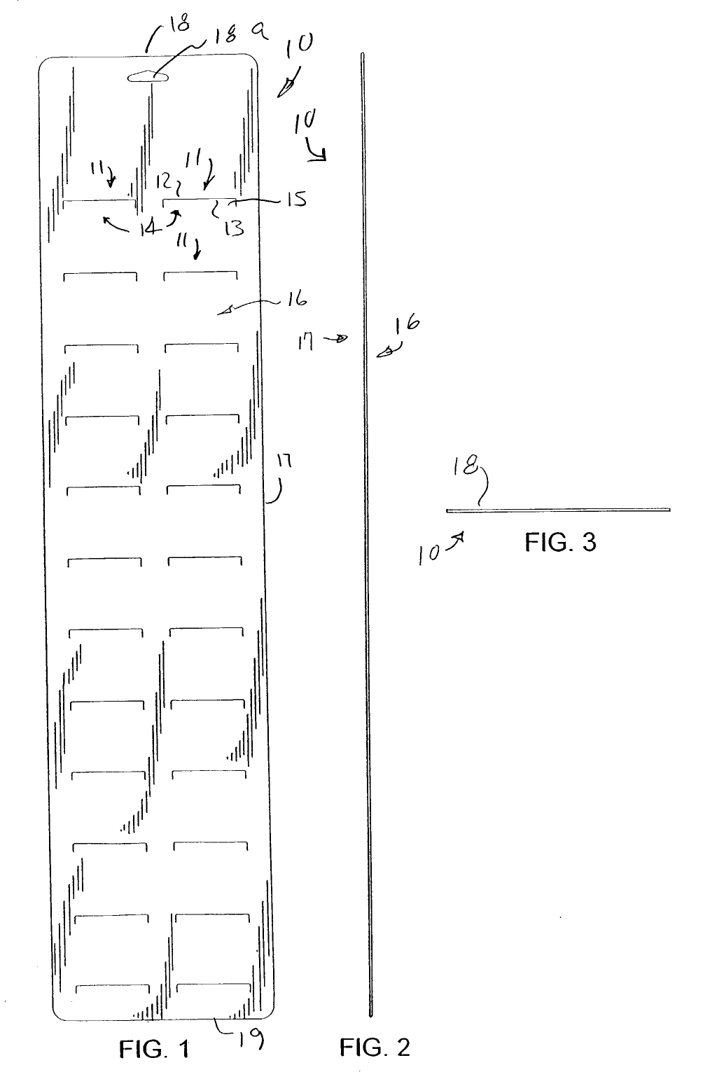

Referring to the drawings, wherein like reference numerals designate like parts in the several figures, and initially to FIGS. 1-3, a point of purchase display 10 is illustrated. The display 10 is made of sheet material, such as cardboard stock, that tends to retain its shape unless deformed, bent or folded by adequate force applied thereto. The display can be made of other materials, if desired, although cardboard is quite convenient and reasonably priced. The display 10, therefore, may be considered a card-like device.

As is illustrated in the drawings, the display 10 is relatively longer than it is wide. The display 10 has a number of slot-like openings 11 that are able to be formed therein. More particularly, the slot-like openings 11 include a portion 12 of the cardboard stock that are outlined or designated by perforations 13, which can be of frangible (breakable) material portions. The frangible perforations 13 may be made by stamping through part or portions of the cardboard stock. A bottom portion 14 of each slot-like opening 11 may serve as a hinge to allow a portion of the cardboard stock material to be bent about the hinge to form a flap 15. The hinge 14 is in effect a living hinge in that the amount of material that has to bend to provide a suitable large opening or suitably shaped opening 11 to accommodate a right-angle device or other device intended for insertion in the opening 11. Other types of hinges may be used, although the illustrated living hinge is convenient, functional and relatively inexpensive in that no additional parts are necessary-the perforations 13 can be broken and the flap 15 can be folded down.

For convenience of reference the display 10 has a front 16 and a back 17, and it also has a top 18 and a bottom 19. An opening 18a in the top 18 of the display 10 is provided to facilitate suspending the display 10 from a rack, pin, etc.

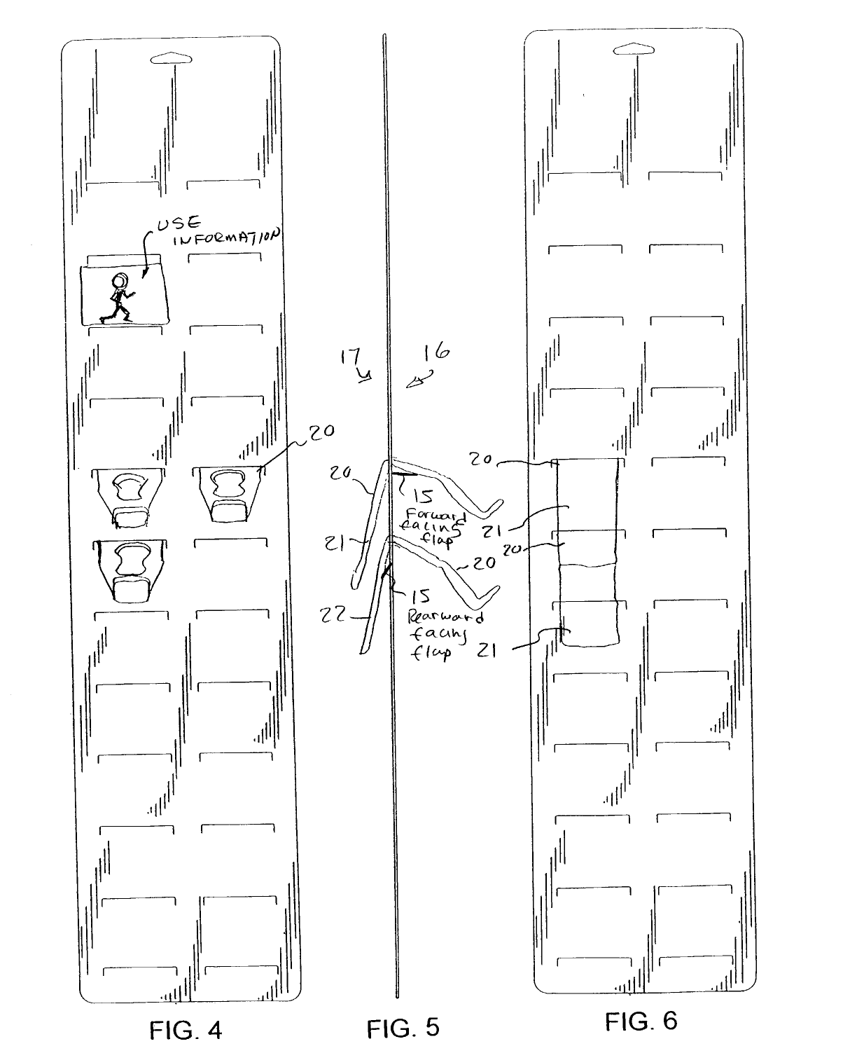

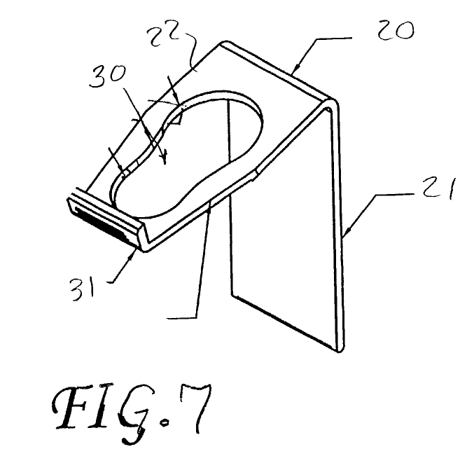

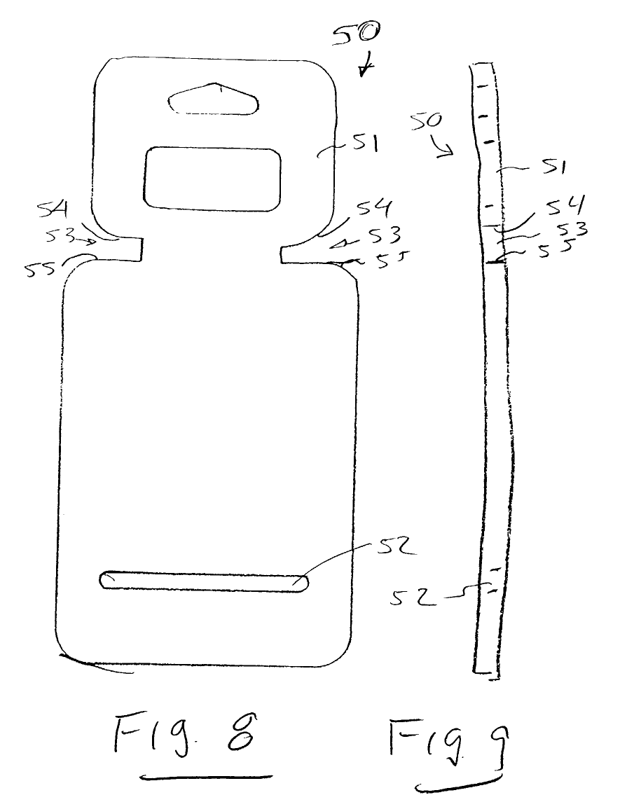

An example of a right-angle device 20 is illustrated in FIGS. 4-7; in FIGS. 4-6 the right angle device 20 is mounted in the point of purchase display 10. As can be seen, the right-angle device has a pair of legs 21, 22 that extend generally at right angles to each other. The precise angular relation is not critical. The legs 21, 22 are of relatively thin gage material; but they have some width and some length extent. One leg 21 is relatively smooth or straight, although, if desired, it could have some other shape characteristics to it. Relative to the display 10, the leg 21 may extend generally in parallel with and adjacent to the back 17. Leg 22 extends outwardly somewhat perpendicularly with respect to the front 16 of the display. The slot-like openings 11 may be spaced relative to each other such that the leg 21 of each of two right-angle devices 20 extend in parallel somewhat overlapping relation while the legs 22 thereof remain extending outward from the front 16 of the display 10. Accordingly, such overlapping legs 21 tend to cooperate with each other to tend to maintain orientation of the legs 22 as the display 10 is moved somewhat while suspended from a rack, support or the like and even while the display 10 is moved from place to place and becomes briefly oriented in other than an upright relation such that the top 18 is above or higher than the bottom 19.

In use of the display 10, a number of right angle devices can be inserted into respective slot-like openings 11. The end of a given leg 21 may be pressed against a flap portion 15 of the cardboard stock of the display 10 so as to break the perforations 13, if this is the initial insertion of an object into the display or not break the perforations if they already are broken, and allow the flap 15 to bend about the hinge 14, if the first time for using the display. If there are no perforations, then there would be no need to break them; and, accordingly, the leg could simply be inserted from the front 16 of the display 10 through a slot-like opening 11 toward the back 17 and then manipulated so as to extend generally in parallel to the back 17.

The folded flap 15 may tend to function to urge the right-angle device 20 to a given orientation, this under cooperative relation of the hinge 14. If the right-angle device 20 is inserted from the front 16 tending to urge the flap toward the back 17, then the flap tends to urge the legs 21 away from the back 17 and the legs 22 in a slightly downward tilted direction. However, if the right-angle devices 20 are inserted into the openings leg 22 first such that the flap 15 tends to fold forward of the front 16 of the display 10, then the flap tends to urge the leg 22 more straight out or perpendicularly to the front of the display 10. In this latter case the top edge of the flap tends to engage the underside of at least part of the leg 22 and to firm up the support thereof.

In using the invention a right-angle device can be inserted into one of the slot-like openings and retained therein for display for possible sale. A customer may withdraw the right-angle device from the slot-like opening to purchase the right-angle device.

According to another method of the invention for displaying right-angle devices that have two legs oriented at generally right angles relative to each other, one leg is inserted through a slot-like opening in a card-like device that has a number of slot-like openings in vertically spaced apart relation, the other leg of the right-angle device is allowed to extend outward from the card-like device, and an overlap is provided for one leg of each of two right-angle devices partly to overlap each other to urge each other to maintain a relatively stable relation to the card-like device and to each other while mounted in the card-like device.

According to another method of displaying right-angle devices that have two legs oriented at generally right angles relative to each other, includes inserting one leg through a slot-like opening in a card-like device that has a number of slot-like openings in vertically spaced apart relation, allowing the other leg of the right-angle device to extend outward from the card-like device, and using a folded flap-like portion of card-like device material to engage at least a portion of one of the legs of a right-angle device to help retain it in position relative to the card-like device.

According to the above methods, the right-angle device 20 can be inserted from the back 17 of the display 10 whereby the flap 15 tends to provide support for the right-angle device; or from the front 16 to allow more flexibility, as was described above.

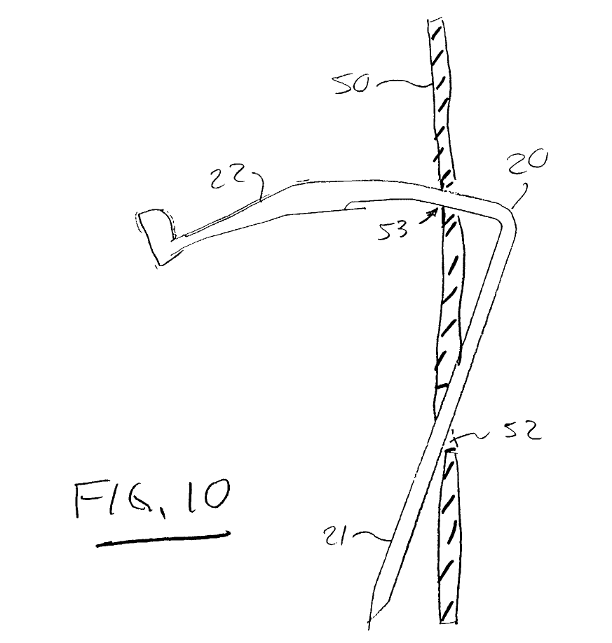

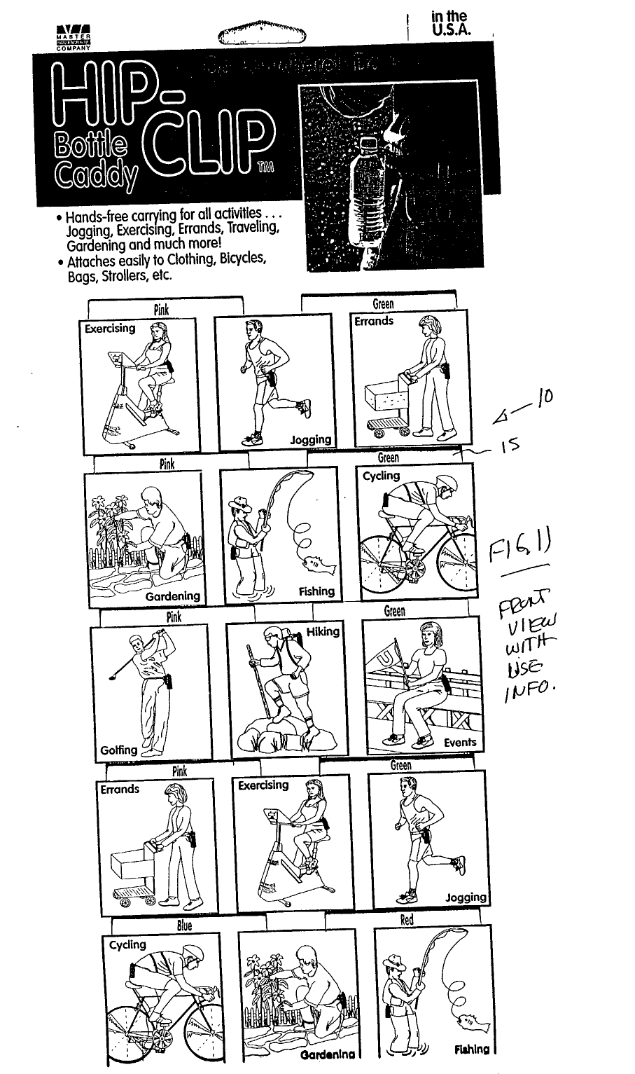

Turning to FIG. 7, an exemplary right-angle device 20 is illustrated. It has back or vertical leg 21 and front or horizontal leg 22. In the horizontal leg 22 is an opening 30, and at the edge of the front leg is a flange 31. The leg 22 and its opening 30 are designed to retain a water bottle or some other bottle or device therein while the vertical leg 21 is placed in a person's belt, pants, skirt, or the like to facilitate carrying the bottle or the like on the person. Reference is made to U.S. Pat. No. 6,394,329 where such a right-angle device 20 is disclosed. The entire disclosure of such patent is incorporated by reference.

It will be appreciated that other types of right angle devices also may be used in connection with the display 10 of the invention and/or in combination with the display as a combination invention.

As is illustrated at 40 in FIG. 1, for example, information may be provided on the display to illustrate or to convey how to use or the various ways to use the right-angle device. One example at 40 shows a runner or walker, and this indicates that the right-angle device could be worn in the belt of a person to carry a water bottle or sports drink while exercising, going for a walk, etc. Other illustrations and information also could be printed or otherwise formed on the sheet material of the display 10 to illustrate and to convey relevant information regarding use of the right-angle device 20.

Briefly turning to FIG. 8, another point of purchase display 40 is illustrated. The display 50 includes a sheet material, such as cardboard stock 51. The sheet material 51 has a slot 52 across the face thereof and has a notch or shoulder 53 with overlapping portions 54, 55 of sheet material. The slot 52 is sized and shaped to receive the leg 21 of the right-angle device 20 or some other such device. The notch or shoulder 53 is of a size and shape to fit withing the opening 30 of the leg 22, while the overlapping portions 54, 55 of the sheet material 51 are positioned relative to the top and bottom of the leg 22, as shown, to cooperate with such leg to retain the sheet material and the leg 22 together. Moreover, with a portion of the leg 21 extending through the slot 52, as shown, and, thus cooperating with the sheet material 51, and the shoulder or notch 53 cooperating with the leg 22, the display 50 and right-angle device 20 are retained as a unit. The display 50 may include printing or the like thereon to advertise the right-angle device and use thereof.

While particular embodiments of the invention have been described in detail, it is understood that the invention is not limited correspondingly in scope, but includes all changes, modifications and equivalents coming within the spirit and terms of the claims appended hereto.

The embodiments of the invention in which exclusive property or privilege is claimed are, as follows:

1. A point of purchase display includes a card-like device of adequate rigidity to retain its shape absent an input, such as a bending, folding or like force, and a number of slot-like openings in the card-like device of a size, shape and placement to receive an elongate member having a given thickness and width accommodated by the slot-like openings.

2. A point of purchase display includes a card-like device of adequate rigidity to retain its shape absent an input, such as a bending, folding or like force, and a number of slot-like openings in the card-like device of a size, shape and placement to receive an elongate member having a given thickness and width accommodated by the slot-like openings, and a foldable portion of the card-like device foldable to at least partly fill a respective slot-like opening and having adequate resiliency when unfolded to maintain some degree of engagement with an elongate member in the slot-like opening.

3. The display of claim 2, wherein the foldable portion is polygonal, is attached at multiple sides to the major extent of the card-like device about at least a portion of the perimeter thereof, at least part of such attachment being perforated to facilitate tearing of the attachments and unfolding of the foldable portion to allow an elongate member to fit into the slot-like opening.

4. The display of claim 2, wherein at least some of the material of the card-like device surrounding the slot-like opening is engageable with an elongate member inserted in the slot-like opening to tend to retain the elongate member in a given positional orientation.

5. The display of claim 2, wherein a generally right-angle member having a pair of respective legs oriented generally at right angle relative to each other is insertable in a slot-like opening such that when the card-like device is vertically oriented, one leg extends parallel to a surface of the card-like device and the other leg protrudes through the slot-like opening in a direction generally perpendicular to the major extent of the card-like device.

6. The display of claim 2, wherein an opening is provided near the top of the card-like device for suspending the card-like device from a rack.

7. The display of claim 2, wherein the slot-like openings are arranged in a number of columns.

8. The display of claim 2, wherein the card-like device is elongate, has two columns of slot-like openings, and has a number of slot-like openings in each column.

9. The display of claim 2, wherein the slot-like openings are arranged in a number of parallel rows.

10. The display of claim 2, wherein the slot-like openings are rectangular

11. The display of claim 2, wherein the slot-like openings have a flap that is hinged at the bottom of each slot-like opening.

12. The display of claim 11, wherein the flap is cut from the major extent of the material of the card-like device with perforations at least at one side of the rectangular shape flap, and wherein the perforations facilitate tearing of the perforate material to open a slot-like opening while the material of the flap pivots about the hinge at the bottom.

13. The display of claim 2, wherein the card-like device includes graphical informational material thereon in proximity to respective slot-like openings to demonstrate uses of the displayed device.

14. The display of claim 2, further comprising a number of right-angle devices mountable in the card-like device, each right-angle device having a pair of legs oriented at approximately right angles with respect to each other, the devices mounted in the card-like device having one leg parallel to one surface of the card-like device and a second leg extending outward from the card-like device, and wherein two proximate and vertically separated right-angle devices mounted in the card-like device have their extending outward second legs in parallel spaced apart relation and at least a portion of each of the one parallel legs extending in parallel overlapping relation.

15. The display of claim 14, wherein the one parallel legs of at least two right-angle devices cooperate with each other to assist in maintaining orientation of the right-angle devices relative to the card-like device.

16. A method of displaying right-angle devices that have two legs oriented at generally right angles relative to each other, comprising
inserting one leg through a slot-like opening in a card-like device that has a number of slot-like openings in vertically spaced apart relation,
allowing the other leg of the right-angle device to extend outward from the card-like device, and
allowing overlap of the one leg of each of two right-angle devices partly to overlap each other to urge each other to maintain a relatively stable relation to the card-like device and to each other while mounted in the card-like device.

17. A method of displaying right-angle devices that have two legs oriented at generally right angles relative to each other, comprising
inserting one leg through a slot-like opening in a card-like device that has a number of slot-like openings in vertically spaced apart relation,
allowing the other leg of the right-angle device to extend outward from the card-like device, and
using a folded flap-like portion of card-like device material to engage at least a portion of one of the legs of a right-angle device to help retain it in position relative to the card-like device.

18. The method of claim 17, wherein the flap-like portion is hinged at the bottom, and further comprising bending the flap-like material about the hinge.

19. The method of claim 18, wherein the flap-like material is formed of the card-like device material and is perforated about the perimeter of at least part of the flap-like material, and further comprising breaking at least some of the perforations to fold the flap-like material about the hinge.

20. A point of purchase display for a right angle device that has two legs oriented at relatively right angles to each other and an opening in one of the legs, comprising
a card having a main body,
notch in the main body for fitting within the opening in one of the legs such that at least part fo the card engages part of the material of the leg,
and a slot in the main body for receiving part of the other.

21. The display of claim 20, wherein the slot is oriented in a direction laterally across at least part of the face of the card, and wherein the leg is relatively long, wide and thin and fits into at least part of the slot.

22. The display of claim 20, wherein the shoulder, material at edges of the shoulder and the slot cooperate to retain the right-angle device and the card together as a unit.
